(19) United States
(12) Patent Application Publication
(10) Pub. No.: US 2013/0100103 A1
(43) Pub. Date: Apr. 25, 2013

(54) DRIVING METHOD OF BI-STABLE DISPLAY PANEL

(71) Applicants: Chun-Chi LAI, Hsin-Chu (TW); Chia-Hsien CHU, Hsin-Chu (TW); Kuo-Hsing CHENG, Hsin-Chu (TW); Chia-Wei HAO, Hsin-Chu (TW)

(72) Inventors: Chun-Chi LAI, Hsin-Chu (TW); Chia-Hsien CHU, Hsin-Chu (TW); Kuo-Hsing CHENG, Hsin-Chu (TW); Chia-Wei HAO, Hsin-Chu (TW)

(73) Assignee: AU OPTRONICS CORP., Hsin-Chu (TW)

(21) Appl. No.: 13/588,076

(22) Filed: Aug. 17, 2012

(30) Foreign Application Priority Data
Oct. 25, 2011 (TW) 100138675

(51) Int. Cl. G09G 5/00

(52) U.S. Cl. 345/211

(57) ABSTRACT

A driving method of a bi-stable display panel includes: providing a handwriting period; and configuring, at an end of the handwriting period, the bi-stable display panel to be driven by dc non-balance to display an image to be displayed.

### TECHNICAL FIELD

The present disclosure relates to a driving method of a display panel, and more particularly to a driving method of a bi-stable display panel.

### BACKGROUND

Compared with the conventional liquid crystal display (LCD) technology, the bi-stable display technology can stably present a black/ or white state without an external voltage supplying to the display elements thereof. In other words, the bi-stable display technology can have a display memory function without a supply of any external voltage, and thus, the bi-stable display technology accordingly can have a less power consumption. Besides, the bi-stable display technology, due to no need of backlights, can further have a small-size and light-weight features. Therefore, the bi-stable display apparatuses realized by the bi-stable display technology can have a longer battery life and accordingly are adapted to be used in some specific electronic apparatus, such as electronic books (e-books), electronic tags and even large-scale electronic boards, etc.

Basically, to display information a bi-stable display apparatus (for example, an electrophoresis display apparatus) is configured to be driven by a driving voltage, which is a differential voltage between a pixel electrode and a common electrode and for a movement of display particles (for example, electrophoresis particles). However, after a driving of the driving voltage, residual charges may occur at the pixel and common electrodes both and consequently led to the electrophoresis particles can have a movement without the driving voltage's driving; therefore, the electrophoresis display apparatus may have the fading or ghosting issues on its displayed image. To prevent the fading or ghosting issues, conventionally the electrophoresis display apparatus is configured to have its display screen driven by dc(direct current) balance. FIG. 1 is a schematic chart of driving waveforms associated with a conventional electrophoresis display apparatus configured to be driven by dc balance during an image updating period. As shown, a common electrode of the electrophoretic display apparatus is configured to be sequentially set at a common voltage Vcom of 0V, 15V, −15V and 0V; a pixel electrode of the electrophoretic display apparatus is configured to be sequentially set at a data voltage Vdata of 0V, −15V, +15V and 0V; and accordingly, the driving voltage Vd (herein, it is assumed that Vd=Vcom−Vdata) between the common electrode and the pixel electrode sequentially is 0V, +30V, −30V and 0V. Herein, the electrophoretic display apparatus is exemplarily configured to perform a grayscale inversion (for example, from a black display to a white display and the grayscale inversion is completed in periods T1, T2). Specifically, to have a black display in period T1 (for example, constituted by a plurality of frames), the common electrode is configured to be set at a common voltage Vcom of +15V and the pixel electrode is configured to be set at a data voltage Vdata of −15V and thereby having a driving voltage Vd of +30V therebetween; accordingly, through the configuration the electrophoretic display apparatus in period T1 can have a black display, and the common and pixel electrodes thereof may have positive and negative residual charges thereat, respectively. Next, to have a white display in period T2 (for example, also constituted by a plurality of frames), the common electrode is configured to be set at a common voltage Vcom of −15V and the pixel electrode is configured to be set at a data voltage Vdata of +15V and thereby having a driving voltage Vd of −30V therebetween; accordingly, through the configuration the electrophoretic display apparatus in period T2 can have a white display, and the common and pixel electrodes thereof may have negative and positive residual charges thereat, respectively. In particular, to realize the dc balance, at the common electrode the negative residual charges occurring in the period T1 will be balanced by the positive residual charges occurring in the period T2; and at the pixel electrode the positive residual charges occurring in the period T1 will be balanced by the negative residual charges occurring in the period T2. In other words, through designing a bi-stable display apparatus to have a specific driving waveform in an image updating period, the dc balance can make a sum of the products of the driving voltage Vd and the periods (or, charges variation amount) equal to zero during the grayscale inversion.

FIG. 2 is a schematic chart of driving waveforms associated with a conventional electrophoresis display apparatus operated in a handwriting period. As shown, the common electrode of each pixel of the electrophoretic display apparatus, in a handwriting period (t1+t2), is configured to be set at a high common voltage Vcom (for example, +15V). In addition, the pixel electrode of a pixel (associated with a handwriting) of the electrophoretic display apparatus, when a handwriting is being performed and in a specific period (for example, a touch period t1), is configured to be set at a low data voltage Vdata (for example, −15V), which is supplied from a driving chip of the electrophoretic display apparatus. Therefore, in the touch period t1 negative black electrophoretic particles will move toward the common electrode and positive white electrophoretic particles will move toward the pixel electrode so as to present a black grayscale for the handwriting. In addition, the pixel electrode of a pixel (associated with a handwriting) of the electrophoretic display apparatus, in a non-touch period t2, is configured to be set at a high data voltage Vdata (for example, +15V), which is supplied from the driving chip of the electrophoretic display apparatus; and accordingly, the driving voltage Vd is configured to be set to 0V so as to make the electrophoresis particles still without moving.

Base on the dc balance, it is understood that the period t1 and the period t2 each are modulated to have a specific time length so as to make the total charges have a variation of zero.

As mentioned above, the handwriting period (t1+t2) is constituted by a plurality of frames, and each frame is associated with one data writing and each data writing is associated with one switching-on and one switching-off of a corresponding pixel; therefore, in the handwriting period (t1+t2) the number of the frames is corresponding to the number of the switching-on and switching-off of each pixel. In particular, the voltage stored in a pixel operated in an On state is configured to be maintained at the data voltage Vdata; however, the voltage stored in a pixel operated in an OFF state is, due to the feed-through caused by a high-to low control signal for controlling the switching-on and switching-off of each pixel, instantly pulled down and will be pulled up to the data voltage Vdata when the pixel is operated in an ON state again. Therefore, the voltage stored in a pixel may not be stably maintained at the data voltage Vdata but has variations as illustrated by the dotted lines 200a, 200b, 200c, 200d, 200e, 200f, 200g, 200h and 200i, which are so-called ripple effect.

Because the driving voltage Vd has a reverse corresponding variation in response to the variation of the voltage stored in a pixel, the driving voltage Vd may not be stably maintained at a fixed value but also have a ripple effect, as illustrated by the dotted lines 210a, 210b, 210c, 210d, 210e, 210f, 210g, 210h and 210i. Thus, the charge amount has a corresponding variation.

Because the ripple effect occurring on the drive voltage Vd, the dc balance may not completely and ideally balance the residual charges in the electrophoresis display apparatus. In fact, after being written by a same character and being performed by the handwriting recognitions several times, the electrophoresis display apparatus may have accumulated feed-through effects and eventually the fading or ghosting issues will occur after a period of time while the image updating period is stop (for example, the electrophoresis display apparatus is shutdown or in a standby state).

### SUMMARY

The disclosure provides a driving method of a bi-stable display panel, which includes: providing a handwriting period; and configuring, at an end of the handwriting period, the bi-stable display panel to be driven by dc non-balance to display an image to be displayed.

The disclosure further provides a driving method of a bi-stable display panel, which includes: configuring a portion of a display area of the bi-stable display panel to be driven by dc non-balance in a first period; and configuring the entire display area of the bi-stable display panel to be driven by dc non-balance in a second period, which is adjacent to and following the first period.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic chart of driving waveforms associated with a conventional electrophoresis display apparatus configured to be driven by dc balance during an image updating period.

FIG. 2 is a schematic chart of driving waveforms associated with a conventional electrophoresis display apparatus operated in a handwriting period.

FIG. 3 is a schematic view of an exemplary display image on a bi-stable display panel in accordance with an embodiment of the present disclosure.

FIG. 4 is a schematic chart illustrating the driving waveforms associated with a touched pixel of the bi-stable display panel in accordance with an embodiment of the present disclosure.

FIG. 5 is a schematic chart illustrating the driving waveforms associated with a non-touched pixel of the bi-stable display panel in accordance with an embodiment of the present disclosure.

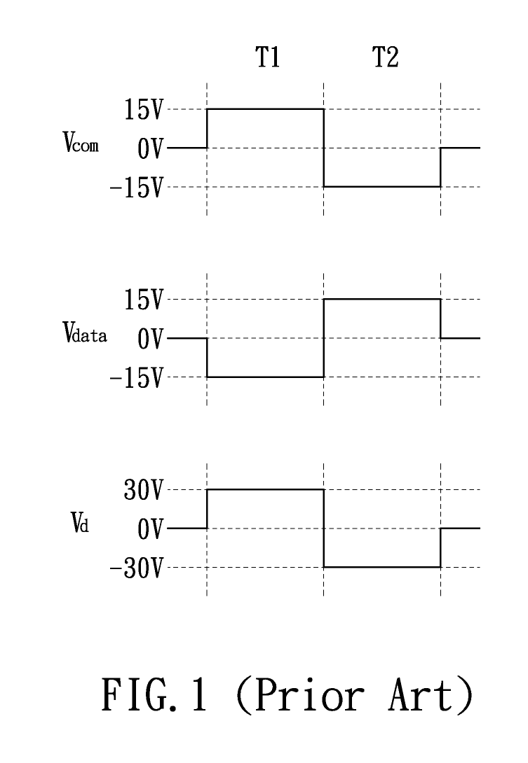

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

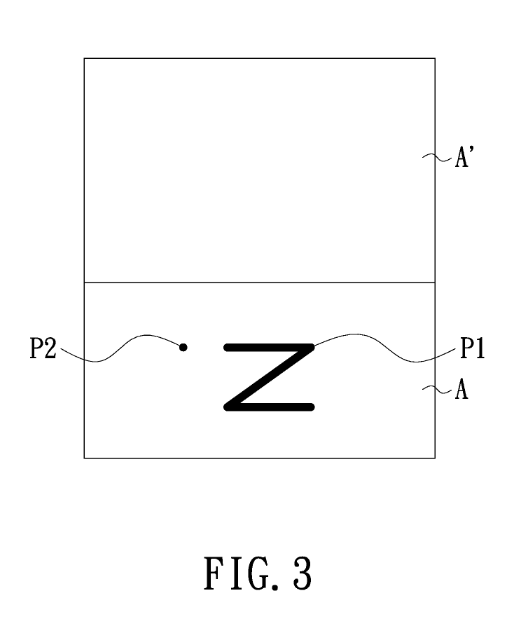

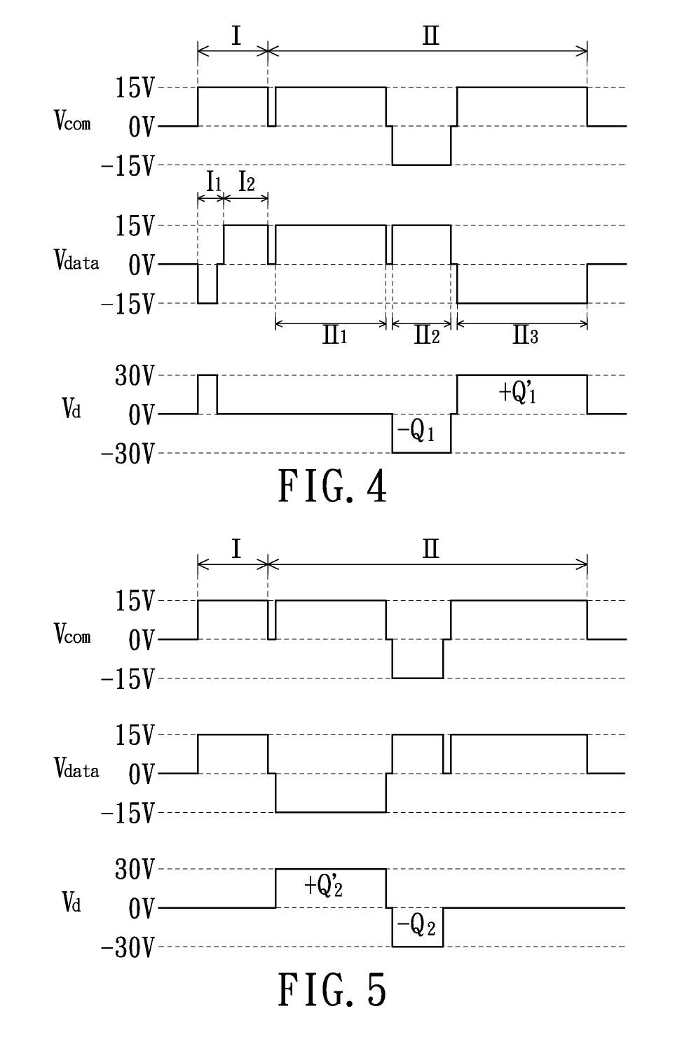

FIG. 3 is a schematic view of an exemplary display image on a bi-stable display panel in accordance with an embodiment of the present disclosure. FIGS. 4, 5 are schematic charts illustrating driving waveforms respectively associated with two pixels of the bi-stable display panel in two periods. In particular, the driving waveforms in FIG. 4 are associated with a pixel P1, which is related to a handwriting track; and the driving waveforms in FIG. 5 are associated with a pixel P2, which is not related to a handwriting track. Likewise, the so-called dc balance is referred to that a bi-stable display panel is configured to have zero charge variation in an image displaying period; and the so-called dc non-balance is referred to that a bi-stable display panel is configured to have non zero charge variation in an image displaying period.

Please refer to FIGS. 3, 4. As shown, the driving method of a bi-stable display panel in accordance with an embodiment is defined to have a first period I, which is referred to a period for handwriting, and a second period II, which is referred to a period for handwriting recognition. In particular, the display area A (an area for a hand writing and also referred to as a handwriting area) of the bi-stable display panel in the first period I is configured to be driven by dc non-balance; and the entire display area (A+A′) of the bi-stable display panel in the second period II, which is adjacent to and following the first period I, is configured to be driven by another dc non-balance. In other words, in the driving method of a bi-stable display panel according to this embodiment, firstly a handwriting period (for example, the first period I) is provided and in the handwriting period a portion of a display area (for example, the handwriting area A) of the bi-stable display panel is configured to be driven by dc non-balance; meanwhile, the display area A′ (a display area of the bi-stable display panel except the handwriting area A) in the handwriting period is configured to be maintained at a same display state (that is, the data voltage Vdata and the common voltage Vcom each are configured to be set at a prior voltage value). Then, the entire display area (for example, the display area (A+A′)) of the bi-stable display panel is configured to be driven by another dc non-balance in next period (for example, the second period II) so as to display a next image.

In the driving method of a bi-stable display panel in accordance with the present embodiment, the first period I and the second period II each can have various definitions. For example, the end of the first period I can be determined based on a duration of a touch event whether or not exceeds a predetermined period; in particular, the first period I is configured to end and accordingly the second period II is configured to start when the duration of a touch event exceeds the predetermined period. In another case, the first period I is configured to start if a touch event is detected and the second period II is automatically configured to start after a specific time (for example, one second) of the end of the touch event. In a further case, the definitions of the first period T1 and the second period T2 are based on whether or not a touch event is detected at a specific position; in particular, the second period II is configured to start if a touch event is detected at a specific position; otherwise, the bi-stable display panel is configured to be maintained in the first period I.

To get a clear understanding of the present embodiment, hereafter the display particles for the information display on the bi-stable display panel are exemplified by positive white display particles. Therefore, if the bi-stable display panel is configured to have a positive driving voltage, which indicates that the common electrode is configured to be set at a voltage level higher than the pixel electrode is, the positive white display particles are driven to move toward the pixel electrode, or, move away from the common electrode; and thus, the associated pixels on the bi-stable display panel each present a black grayscale. Alternatively, if the bi-stable display panel is configured to have a negative driving voltage, which indicates that the common electrode is configured to be set at a voltage level lower than the pixel electrode is, the positive white display particles are driven to move toward the common electrode, or, move away from the pixel electrode; and thus, the associated pixels on the bi-stable display panel each present a white grayscale. It is understood that the driving method disclosed in the present embodiment is not only applied to the electrophoretic particles with a positive polarity only, but also applied to the electrophoretic particles with a positive and a negative polarity both. Therefore, the following description for the driving method of the present embodiment is not limited to positive (or, negative) particles only.

Specifically, in the present embodiment the first period I is divided into a touch period I₁ and a non-touch period I₂, and each is constituted by a plurality of frames. Initially, the handwriting area A is, for example, configured to present a white grayscale at the beginning of the first period I. The common electrode of each pixel in the handwriting area A is configured to be set at a high common voltage Vcom (for example, +15V) in the first period I; the pixel electrode of a pixel associated with a handwriting (for example, the pixel P1 in FIG. 3) is configured to be set at a low data voltage Vdata (for example, −15V) in the touch period I₁; and consequently, the pixel P1 is converted from displaying a white grayscale into displaying a black grayscale after being driven by a plurality of frames in the touch period I₁. In the non-touch period I₂, the pixel electrode of the pixel P1 is configured to be set at a high data voltage Vdata (for example, +15V), and the bi-stable display panel is configured to be maintained at a displaying state at the end of the touch period I₁. In addition, as shown in FIG. 5, the pixel electrode of a pixel not associated with a handwriting (for example, the pixel P2 in FIG. 3) is configured to be set at a high data voltage Vdata (for example, +15V) in the first period I, and accordingly, the driving voltage Vd associated with the pixel P2 is configured to be set at 0V so as to lead to the display particles associated with the pixel P2 maintain at a still state without moving.

Then, in the second period II, the bi-stable display panel is configured to have its entire display area (A+A′) driven by dc non-balance to display the recognition result of the contents of the hand writing in the display area A. Specifically, in the second period II, firstly a sequence of the supplies of a first amount of positive charges and a second amount of negative charges is set. Herein, it is understood that, under a condition of a fixed current, the number of charges supplied to each pixel is proportional to the driving voltage, and the moving speed of each display particle is also associated with the driving voltage; therefore, the charges provided in the second period II eventually can be expressed by the moving distances of the display particles. As a result, in the present embodiment the next image to be displayed on the bi-stable display panel can be formed by the first amount of positive charges and the second amount of negative charges supplied to the each pixel thereof. Moreover, it is to be noted that, in order to balance the dc non-balance situation occurring in the handwriting period, the first amount and the second amount are designed to be different to each other.

It is understood that, in the second period II, each pixel is configured to be supplied with positive/ or negative charges from an associated data line as long as the associated data voltage Vdata and the associated common voltage Vcom are configured to be different to each other. For example, as illustrated in FIG. 4, in the period that the data voltage Vdata and the common voltage Vcom both are configured to be set at 0V and accordingly the driving voltage Vd is 0V (herein, it is assumed that Vd=Vcom−Vdata), thus, in the period the pixel P1 is configured to be supplied with no any spare positive/ or negative charges. Similarly, in the period II₁ that the data voltage Vdata and the common voltage Vcom both are configured to be set at +15V and accordingly the driving voltage Vd is 0V, thus, in the period II₁ the pixel P1 is configured to be supplied with no any spare positive/ or negative charges.

Alternatively, because the data voltage Vdata and the common voltage Vcom are, in the period II₂, configured to be respectively set at +15V, −15V and accordingly the driving voltage Vd is −30V, thus, in the period II₂ the pixel P1 is configured to be supplied with charges (−Q). In other words, positive display particles are driven by the driving voltage Vd of −30V to move toward the common electrode in the period II₂. On the contrary, because the data voltage Vdata and the common voltage Vcom are, in the period II₃, configured to be respectively set at −15V, +15V and accordingly the driving voltage Vd is +30V, thus, in the period II₃ the pixel P1 is configured to be supplied with charges (+Q′). In other words, positive display particles are driven by the driving voltage Vd of +30V to move toward the pixel electrode in the period II₃.

In the present embodiment, it is understood that the differential charge amount between the supplied positive and negative charges as well as the sequence of the supplies the positive and negative charges can be modulated based on the grayscale difference between the image desired to be displayed and the prior image.

Specifically, the displaying of the result of the handwriting recognition can be implemented by many ways. For example, before the result of the handwriting recognition is displayed, one image with a specific color is configured to be inserted and displayed (herein, the operation time of the inserting and displaying the specific-color image is referred to as an image updating period) and meanwhile in the image updating period the bi-stable display panel is configured to be driven by dc non-balance so as to achieved the means of providing different amounts of positive charges and negative charges. In other words, after the hand writing but before the result of the handwriting recognition is displayed, an image with a specific color is configured to be inserted and displayed therebetween. However, no matter the specific-color image is black same as the handwriting track is, or is white same as the background is (or, handwriting track is white and the background is black), this specific-color image may have a side effect that causes a visible non-smoothness and consequently makes user feel uncomfortable.

With the rapid development of computing speed, today the handwriting recognition time is much shorter. Accordingly, in an embodiment the supplies of positive/ or negative charges after the handwriting can be configured to be integrated into the displaying of the result of the handwriting recognition. That is, instead of inserting and displaying a specific-color image, in the embodiment the image of the result of the handwriting recognition is formed by the supplied positive/ or negative charges. In other words, in the previous embodiment an extra specific-color image (or, an object image) is inserted between an image of handwriting and an image of the result of the handwriting. In the present embodiment, the object image following the image of handwriting is the image of the result of the handwriting. Therefore, in the previous embodiment the operation period for the specific-color image inserting is referred to as an image updating period; and in the present embodiment the operation period for the image of the result of the handwriting recognition displaying is referred to as an image updating period. Hence, compared with the previous embodiment, according to the present embodiment users will not sense an operation delay, due to without an extra inserted image, and consequently the displaying speed increases, due to two images are integrated into one.

To sum up, the bi-stable display panel is configured to, at the end of the first period I, display an image as illustrated in FIG. 3; and at the end of the second period II the bi-stable display panel is configured to display a next image with the result of the handwriting recognition. In other words, the bi-stable display panel is configured to be converted from displaying one image to another image via a driving in the second period II.

Specifically, as illustrated in FIGS. 3, 4, the pixel P1 (associated with a handwriting) of the bi-stable display panel, in the second period II, firstly is configured to be supplied with negative charges (−Q₁) and then supplied with positive charges (+Q₁′); wherein the dc non-balance, caused by the negative charges (−Q₁) and the positive charges (+Q₁′), can be expressed by a formula of a driving voltage timing a driving period. That is, the pixel P1 in the period II firstly has, for example, a dc non-balance of −4800 Vms (−30V*160 ms) and then a dc non-balance of +9600 Vms (+30V*320 ms); herein it is assumed that the duration of the supply of negative charges (−Q₁) is 160 ms and the duration of the supply of positive charges (+Q₁′) is 320 ms. Therefore, in the entire second period II the pixel P1 is configured to be driven by a dc non-balance of +4800 Vms (+9600 Vms+(−4800 Vms)) to display the next image.

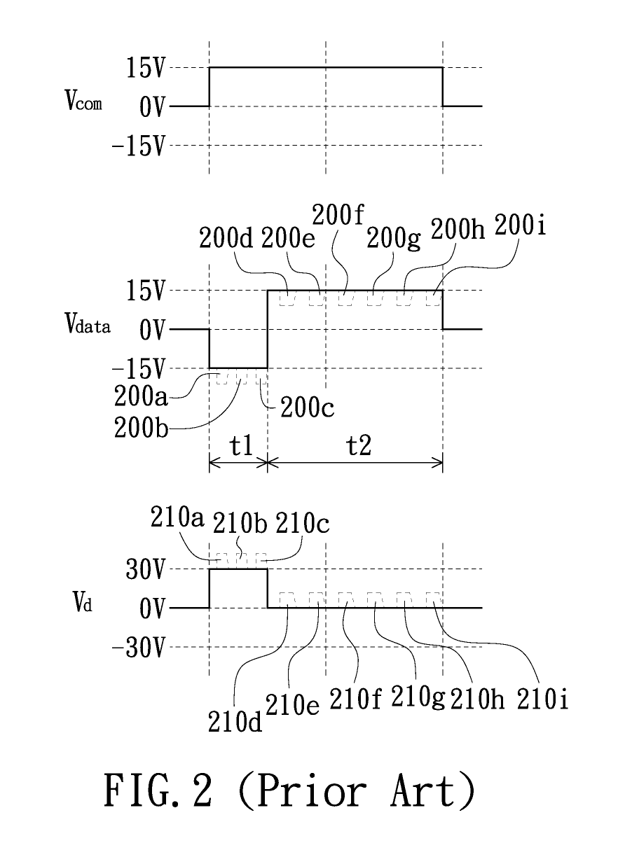

In addition, as illustrated in FIGS. 3, 5, the pixel P2 (not associated with a handwriting) of the bi-stable display panel, in the first period I, is configured to be supplied with a data voltage Vdata of +15V same as the voltage value of the common voltage Vcom has. It is to be noted that the pixel P2 still is, even the pixel P2 is not associated any handwriting, configured to be written by many frames in the first period I and thereby resulting in its data voltage Vdata as well as its driving voltage Vd having ripples (for example, as illustrated the dashed lines 200a-200i in FIG. 2), and accordingly the dc-balance driving may not be realized ideally in the first period I.

As illustrated in FIG. 5, the pixel P2 of the bi-stable display panel, in the second period II, firstly is configured to be supplied with positive charges (+Q₂′) and then supplied with negative charges (−Q₂); wherein the dc non-balance, caused by the negative charges (−Q₂) and the positive charges (+Q₂′), can be expressed by a formula of a driving voltage timing a driving period. That is, the pixel P2 in the period II firstly has, for example, a dc non-balance of +9600 Vms (+30V*320 ms) and then a dc non-balance of −4800 Vms (−30V*160 ms); herein it is assumed that the duration of the supply of positive charges (+Q₂′) is 320 ms and the duration of the supply of negative charges (−Q₂) is 160 ms. Therefore, in the entire second period II the pixel P2 is configured to be driven by a dc non-balance of +4800 Vms (+9600 Vms+(−4800 Vms)) to display the next image.

The sequence of the supplies of the positive/ or negative charges to the pixels P1, P2 are adjustable and each supply can be divided into multiple sections. For example, the supply of positive charges can be divided into three sections and the supply of negative charges can be divided into five sections. In addition, positive charges can be supplied first and then the supply of negative charges; or, negative charges can be supplied first and then the supply of positive charges; or the supplies of positive and negative charges can be performed in turn and one after another. To sum up, according to the disclosure, the amount of supplied positive charges and the amount of supplied negative charges are designed to be different to each other and have a differential value therebetween, and the supply sequence and the supply numbers for the positive and negative charges can be modulated based on an actual condition.

In addition, in order to eliminate the fading or ghosting situations more efficiently, the amount of positive and negative charges provided in the second period II can be modulated based on the differential amount of positive and negative charges generated in the first period I, and accordingly, the bi-stable display panel is dc balanced more completely.

To have a simpler operating process, it is understood that, in a preferred embodiment, the bi-stable display panel is configured to be driven by dc balance in the time except the first period I and the second period II. In other words, except the first period I and the second period II, the bi-stable display panel is configured to be driven by dc balance so as to avoid a complicate circuit design.

In summary, in the driving method of a bi-stable display panel according to the disclosure, the bi-stable display panel, after a handwriting period, is configured to be driven by dc non-balance to display a next image, thus, the fading and ghosting issues, which may be caused by the free-through effect occurring in the handwriting period, are prevented. As a result, the driving method of a bi-stable display panel according to the disclosure is capable of avoiding the occurrences of fading and ghosting issues on the display images.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving method of a bi-stable display panel, comprising:
providing a handwriting period; and
configuring, at an end of the handwriting period, the bi-stable display panel to be driven by dc non-balance to display an image to be displayed.

2. The driving method according to claim 1, wherein the step of configuring, at an end of the handwriting period, the bi-stable display panel to be driven by dc non-balance to display an image to be displayed comprises:
ending the handwriting period and entering into an image updating period;
setting a sequence of supplies of a first amount of positive charges and a second amount of negative charges in the image updating period; and
supplying, according to the sequence, the first amount of positive charges and the second amount of negative charges to data lines associated with the bi-stable display panel to form the image to be displayed,
wherein the first amount and the second amount are different to each other.

3. The driving method according to claim 2, wherein the supplied charges with a number of a difference between the first and second amounts are provided by an inserted frame having a color same as a handwriting track has in the handwriting period.

4. The driving method according to claim 2, wherein the step of ending the handwriting period comprises:
determining whether or not the handwriting period has exceeded a predetermined time; and
ending the handwriting period if it has exceeded the predetermined time.

5. A driving method of a bi-stable display panel, comprising:
configuring a portion of a display area of the bi-stable display panel to be driven by dc non-balance in a first period; and
configuring the entire display area of the bi-stable display panel to be driven by dc non-balance in a second period, which is adjacent to and following the first period.

6. The driving method according to claim 5, further comprising a step of:
configuring the bi-stable display panel to be driven by charge-balance in an entire period except the first and second periods.

7. The driving method according to claim 5, wherein the step of configuring the entire display area of the bi-stable display panel to be driven by dc non-balance in a second period comprises:
setting a sequence of supplies of a first amount of positive charges and a second amount of negative charges in the second period; and
supplying, according to the sequence, the first amount of positive charges and the second amount of negative charges to data lines associated with the bi-stable display panel to form the image to be displayed,
wherein the first amount and the second amount are different to each other.

8. The driving method according to claim 5, wherein the first period is a handwriting period and the second period is a handwriting recognition period.

9. The driving method according to claim 5, wherein in the first period, the bi-stable display panel is configured, while the portion of the display area of the bi-stable display panel is driven by dc non-balance, to have its rest portion of the display area to be maintained at a same display state.

10. A driving apparatus for use in a bi-stable display panel, comprising:
means for providing a handwriting period; and
means for configuring, at an end of the handwriting period, the bi-stable display panel to be driven by dc non-balance to display an image to be displayed.

11. The driving apparatus according to claim 10, wherein means for configuring, at an end of the handwriting period, the bi-stable display panel to be driven by dc non-balance to display an image to be displayed further comprises:
means for ending the handwriting period and entering into an image updating period;
means for setting a sequence of supplies of a first amount of positive charges and a second amount of negative charges in the image updating period; and
means for supplying, according to the sequence, the first amount of positive charges and the second amount of negative charges to data lines associated with the bi-stable display panel to form the image to be displayed,
wherein the first amount and the second amount are different to each other.

12. The driving apparatus according to claim 11, wherein means for ending the handwriting period and entering into an image updating period comprises:
means for determining whether or not the handwriting period has exceeded a predetermined time; and
means for ending the handwriting period if it has exceeded the predetermined time.
